(19) United States
(12) Patent Application Publication
(10) Pub. No.: US 2008/0141275 A1
(43) Pub. Date: Jun. 12, 2008

(54) Filtering Application Messages In A High Speed, Low Latency Data Communications Environment

(76) Inventors: Kenneth W. Borgendale, Austin, TX (US); Gidon Gershinskey, Haifa (IL); Nir Naaman, Haifa (IL); Foluso O. Okunseinde, Austin, TX (US); Cornell G. Wright, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/609,696

(22) Filed: Dec. 12, 2006

(51) Int. Cl. G06F 3/00

(52) U.S. Cl. 719/313

(57) ABSTRACT

Methods, systems, and products are disclosed for filtering application messages in a high speed, low latency data communications environment that include: establishing, in a transport engine of a subscribing client device, a transport layer constraint on application messages to be received by the subscribing client device from a feed adapter; receiving, in the transport engine of the subscribing client device from the feed adapter, an application message; determining, by the transport engine of the subscribing client device, whether contents of the application message satisfy the transport layer constraint; and administering the application message, by the transport engine of the subscribing client device, in dependence upon whether the contents of the application message satisfy the transport layer constraint.

### BACKGROUND OF THE INVENTION

1. Field of the Invention

The field of the invention is data processing, or, more specifically, methods, systems, and products for filtering application messages in a high speed, low latency data communications environment.

2. Description of Related Art

Messaging environments are generally available to provide data communication between message sending devices and message receiving devices using messages. A message is a quantity of data that includes one or more data fields and is passed from a message producer installed on a message sending device to a message consumer installed on a message receiving device. A message may represent, for example, numeric or textual information, images, encrypted information, and computer program instructions.

A messaging environment may support point-to-point messaging, publish and subscribe messaging, or both. In a point-to-point messaging environment, a message producer may address a message to a single message consumer. In a publish and subscribe messaging environment, a message producer may publish a message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

For further explanation of a messaging environment, FIG. 1 sets forth a block diagram illustrating a typical messaging environment for data communications that includes a message sending device (100), a message receiving device (104), and a message administration server (102). The message sending device (100) is a computer device having installed upon it a message producer (110), a set of computer program instructions configured for transmitting messages to the message administration server (102) for delivery to a message receiving device. In the example of FIG. 1, the message producer (110) transmits messages to the message administration server (102) on a message stream (106). The message sending device (100) may produce the transmitted messages by generating the messages from data of the message sending device itself or data received from some other source. The message receiving device (104) is a computer device having installed upon it a message consumer (112), a set of computer program instructions configured for receiving messages from the message administration server (102). In the example of FIG. 1, the message consumer (112) receives the messages from the message administration server (102) on a message stream (108). In the example of FIG. 1, the message stream (106) and the message stream (108) are data communication channels implemented using, for example, the User Datagram Protocol (‘UDP’) and the Internet Protocol (‘IP’).

In either a point-to-point messaging environment or a publish and subscribe messaging environment, the messages transmitted from message sending devices to message receiving devices typically pass through the message administration server (102). The message administration server (102) is computer device having installed upon it a message administration module (114), computer program instructions configured for administering the messages transmitted from the message producer (110) to the message consumer (112). Examples of message administration modules may include the IBM WebSphere® MQ, the Open Message Queue from Sun Microsystems, and the OpenJMS from The OpenJMS Group. In a point-to-point messaging environment, the message administration module (114) provides message queuing for the message consumer (112) as the message administration module (114) receives messages addressed to the consumer (112) from various message providers. In a publish and subscribe messaging environment, the message administration module (114) administers the various channels or topics to which message producers publish and message consumers subscribe. In either message environment, the message administration module (114) may also provide security services to ensure that the only messages arriving at the messaging consumer (112) from the message producer (110) are those messages that the message consumer (112) is authorized to receive and that the message producer (110) is authorized to send.

Current messaging environments such as, for example, the one described above with reference to FIG. 1, have certain drawbacks. Messages transmitted to a message administration server from a message sending device for delivery to a message receiving device are delayed in the message administration server until the message administration server can process the messages. The message processing that occurs in the message administration server typically increases the overall messaging latency of the messaging environment and decreases the overall speed for transmitting data in the data communications environment. Messaging latency is the time period beginning when the message producer transmits a message and ending when the message consumer receives the message.

In many data communication environments, even slight increases in messaging latency are costly. Consider, for example, a financial market data environment. A financial market data environment is a data processing environment used to communicate information about financial markets and participants in financial markets. In a financial market data environment, a message is commonly referred to as a ‘tick’ and represents financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. In a financial market data environment, a message producer may provide quotes for the purchase or sale of financial securities based on real-time financial market conditions, and a message consumer may buy and sell financial securities based on financial quotes. When a message consumer buys or sells a financial security based on the quoted price provided by the message producer, the ability of a message consumer to obtain the bid or ask in the quote for the financial security is largely influenced by messaging latency in the financial market data environment. The higher the messaging latency, the less likely a buy or sell order generated by the message consumer will execute at or near the price stated in the financial quote. In fact, a highly volatile security may fluctuate in price dramatically over a time period of a few seconds.

Current solutions to reduce messaging latency are to remove the message administration server from the messaging environment. In such current solutions, the message sending devices send messages directly to message receiving devices. The drawback to such current solutions is that removing the message administration server removes the administration functionality provided by the message administration server from the messaging environment. Current solutions, therefore, effectively offer no solution in messaging environments where the administrative functions of a message administration server are required. Consider again the financial market data environment example from above. In such an exemplary financial market data environment, consider that a message receiving device is only authorized to receive financial quotes on certain financial securities or only authorized to receive financial quotes that are at least fifteen minutes old. Removing the message administration server from such a financial market data environment removes the ability to administer the messages received by the message receiving device from the message sending device in the financial market data environment.

### SUMMARY OF THE INVENTION

Methods, systems, and products are disclosed for filtering application messages in a high speed, low latency data communications environment that include: establishing, in a transport engine of a subscribing client device, a transport layer constraint on application messages to be received by the subscribing client device from a feed adapter; receiving, in the transport engine of the subscribing client device from the feed adapter, an application message; determining, by the transport engine of the subscribing client device, whether contents of the application message satisfy the transport layer constraint; and administering the application message, by the transport engine of the subscribing client device, in dependence upon whether the contents of the application message satisfy the transport layer constraint.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a typical messaging environment for data communications.

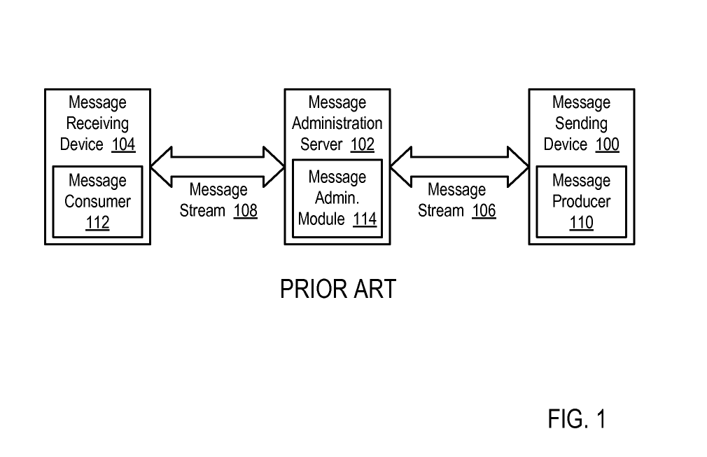

FIG. 2 sets forth a network and block diagram illustrating an exemplary computer data processing system for filtering application messages in a high speed, low latency data communications environment according to exemplary embodiments of the present invention.

FIG. 3 sets forth a block diagram of automated computing machinery comprising an exemplary subscribing client device useful in filtering application messages in a high speed, low latency data communications environment according to exemplary embodiments of the present invention.

FIG. 4 sets forth a flowchart illustrating an exemplary method of filtering application messages in a high speed, low latency data communications environment in a high speed, low latency data communications environment according to exemplary embodiments of the present invention.

FIG. 5 sets forth a flowchart illustrating a further exemplary method of filtering application messages in a high speed, low latency data communications environment in a high speed, low latency data communications environment according to exemplary embodiments of the present invention.

FIG. 6 sets forth a flowchart illustrating a further exemplary method of filtering application messages in a high speed, low latency data communications environment in a high speed, low latency data communications environment according to exemplary embodiments of the present invention.

FIG. 7 sets forth a flowchart illustrating a further exemplary method of filtering application messages in a high speed, low latency data communications environment in a high speed, low latency data communications environment according to exemplary embodiments of the present invention.

FIG. 8 sets forth a flowchart illustrating a further exemplary method of filtering application messages in a high speed, low latency data communications environment in a high speed, low latency data communications environment according to exemplary embodiments of the present invention.

### DETAILED DESCRIPTION OF EXEMPLARY EMBODIMENTS

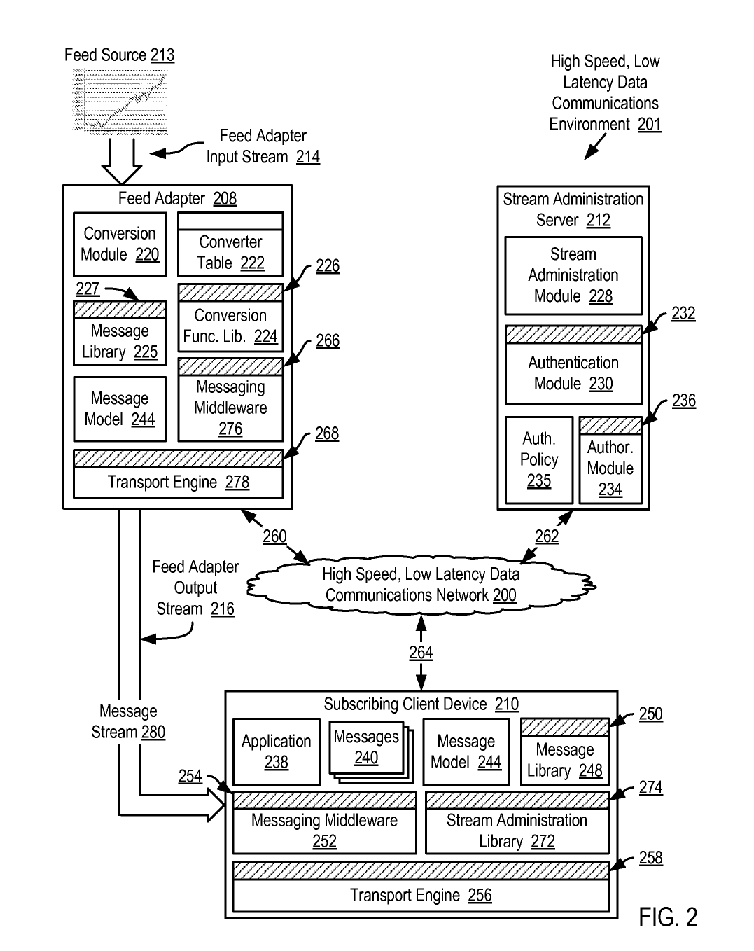

Exemplary methods, systems, and products for filtering application messages in a high speed, low latency data communications environment according to embodiments of the present invention are described with reference to the accompanying drawings, beginning with FIG. 2. FIG. 2 sets forth a network and block diagram illustrating an exemplary computer data processing system for filtering application messages in a high speed, low latency data communications environment according to embodiments of the present invention. The system of FIG. 2 operates generally for filtering application messages in a high speed, low latency data communications environment according to embodiments of the present invention as follows: A transport layer constraint is established in a transport engine (256) of a subscribing client device (210). The transport layer constraint is a constraint on application messages to be received by the subscribing client device (210) from a feed adapter (208). The transport layer constraint is applied to the application messages by a software component operating in the transport layer of the network protocol stack as opposed to being applied by a software component operating in the application layer. The transport engine (256) of the subscribing client device (210) receives an application message from the feed adapter (208). The transport engine (256) of the subscribing client device (210) determines whether contents of the application message satisfy the transport layer constraint. The transport engine (256) of the subscribing client device (210) administers the application message in dependence upon whether the contents of the application message satisfy the transport layer constraint. In the example of FIG. 2, a stream administration server (212) may also broker establishment of a message stream (280) from the feed adapter (208) to the subscribing client device (210) by authenticating the subscribing client device (210), authorizing the subscribing client device (210) to receive application messages from the feed adapter (208) on the message stream (280), and providing to the transport engine (256) of the subscribing client device (210) the transport layer constraint.

The high speed, low latency data communications environment (201) illustrated in FIG. 2 includes a high speed, low latency data communications network (200). The network (200) includes a feed adapter (208), a stream administration server (212), and a subscribing client device (210), as well as the infrastructure for connecting such devices (208, 212, 210) together for data communications. The network (200) of FIG. 2 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 2 may be referred to as a ‘minimally routed network.’ Although the exemplary network (200) illustrated in FIG. 2 does not include a router, such a minimally routed network is for explanation only. In fact, some high speed, low latency networks useful in filtering application messages in a high speed, low latency data communications environment according to embodiments of the present invention may include a router.

The high speed, low latency data communications environment (201) depicted in FIG. 2 includes a message stream (280). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 2 includes a stream administration server (212) connected to the high speed, low latency data communications network (200) through a wireline connection (262). The stream administration server (212) of FIG. 2 is a computer device having installed upon it a stream administration module (228), an authentication module (230), an authorization module (234), and an authorization policy (235). A stream administration module (228) is a software component that includes a set of computer program instructions configured for filtering application messages in a high speed, low latency data communications environment according to embodiments of the present invention. The stream administration module (228) operates generally for filtering application messages in a high speed, low latency data communications environment according to embodiments of the present invention by brokering establishment of a message stream (280) from the feed adapter (208) to the subscribing client device (210), including authenticating the subscribing client device (210), authorizing the subscribing client device (210) to receive application messages (240) from the feed adapter (208) on the message stream (280), and providing to the transport engine (256) of the subscribing client device (210) the transport layer constraint.

The authentication module (230) of FIG. 2 is a set of computer program instructions capable of providing authentication security services to the stream administration module (228) through an exposed authentication application programming interface (‘API’) (232). Authentication is a process of verifying the identity of an entity. In the exemplary system of FIG. 2, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 2 is a set of computer program instructions capable of providing authorization security services to the stream administration module (228) through an exposed authorization API (236). Authorization is a process of only allowing resources to be used by resource consumers that have been granted authority to use the resources. In the example of FIG. 2, the authorization module (234) identifies the application messages that the subscribing client device (210) is authorized to receive on the message stream (280). The authorization module (234) of FIG. 2 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 2, feed adapter (208) is connected to the high speed, low latency data communications network (200) through a wireline connection (260). The feed adapter (208) is a computer device having the capabilities of converting application messages received on a feed adapter input stream (214) having a first format to application messages having a second format for transmission on a feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 2, the feed adapter (208) receives application messages on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center_{SM} which is an electronic screen-based equity securities market in the United States. In a financial market data environment, a feed adapter input stream is referred to as a ‘financial market data feed.’

The feed adapter (208) of FIG. 2 has installed upon it a conversion module (220), a converter table (222), conversion function library (224), a message library (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 2 is a data structure that specifies the converter functions capable of converting the application message from one format to another format. Utilizing multiple converter tables, the conversion module (220) may convert messages from a variety of input formats to a variety of output formats. In the example of FIG. 2, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 2 may be implemented using a structured document such as, for example, an eXtensible Markup Language (‘XML’) document.

The conversion function library (224) of FIG. 2 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 2, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 2, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). That is, the message model (244) specifies a message format for interpreting application messages and includes one or more field specifications. Each field specification specifies a message field for storing data in an application message and includes field characteristics of the message field. In the example of FIG. 2, the message model (244) is established on both the feed adapter (208) and the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 2, the conversion module (220) and the converter functions of the conversion function library (224) process the data contained in the application messages (240) using the message library (225). The message library (225) is a software module that includes a set of functions for creating, accessing, and manipulating messages (240) according to a message model (244). The message library (225) is accessible to the conversion module (220), the converter functions of the conversion function library (224), and the messaging middleware (276) through a message API (227) exposed by the message library (225).

Before the conversion module (220) of FIG. 2 performs data processing on the application messages, the conversion module (220) receives application messages (not shown) having a first format from the feed source (213). The conversion module (220) of FIG. 2 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 2 performs data processing on the application messages received from the feed source (213), the conversion module (220) provides the application messages having the second format to the mess aging middleware (276). The messaging middleware (276) of FIG. 2 is a software component that provides high availability services between the feed adapter (208), any backup feed adapter that may exist, the subscribing client device (210), and the feed source (213). In addition, the messaging middleware (276) of FIG. 2 includes a set of computer program instructions capable of filtering application messages in a high speed, low latency data communications environment according to embodiments of the present invention. The messaging middleware (276) operates generally for filtering application messages in a high speed, low latency data communications environment according to embodiments of the present invention by receiving, from a conversion application of the feed adapter (208), application messages for transmission to the subscribing client device (210), retrieving the contents of each of the application messages, and calculating a message contents proxy for each message in dependence upon the retrieved contents of each application message. The message contents proxy is a value representing the contents of the application message. The messaging middleware (276) then provides the received application messages to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 2 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for filtering application messages in a high speed, low latency data communications environment according to embodiments of the present invention. The transport engine (278) operates generally for filtering application messages in a high speed, low latency data communications environment according to embodiments of the present invention by transmitting the application messages (240) and the message contents proxies to the subscribing client device. The messaging middleware (276) operates the transport engine (278) through a transport API (268) exposed by the transport engine (278). The transport engine (278) of FIG. 2 may transmit the application messages (240) and the message contents proxies by receiving the application messages (240) and the message contents proxies from the messaging middleware (276), prepending each message contents proxy to its corresponding application message, encapsulating the application messages and the message contents proxies provided by the messaging middleware (276) into transport packets, and transmitting the packets through the message stream (280) to the subscribing client device (210).

The subscribing client device (210) in exemplary system of FIG. 2 connects to the high speed, low latency data communications network (200) through a wireline connection (264). The subscribing client device (210) of FIG. 2 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 2, the subscribing client device (210) has installed upon it an application (238), a message library (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the message library (248). The message library (248) is software module that includes a set of functions for creating, accessing, and manipulating messages (240) according to the message model (244) that is installed on both the feed adapter (208) and the subscribing client device (210). The message library (248) is accessible to the application (238) through a message API (250) exposed by the message library (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the subscribing client device (210) of FIG. 2 may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) includes a set of computer program instructions for filtering application messages in a high speed, low latency data communications environment according to embodiments of the present invention. The messaging middleware (252) of FIG. 2 operates generally for filtering application messages in a high speed, low latency data communications environment according to embodiments of the present invention by establishing a middleware layer constraint on application messages to be provided to the application (238) of the subscribing client device (210), calculating the transport layer constraint in dependence upon the middleware layer constraint, and providing the transport layer constraint to the transport engine (256) of the subscribing client device (210). The application (238) and the stream administration library (272) interact with the messaging middleware (252) through a messaging middleware API (254).

The transport engine (256) of FIG. 2 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that includes a set of computer program instructions configured for filtering application messages in a high speed, low latency data communications environment according to embodiments of the present invention. The transport engine (256) operates generally for filtering application messages in a high speed, low latency data communications environment according to embodiments of the present invention by establishing, in the transport engine (256), the transport layer constraint on application messages to be received by the subscribing client device (210) from the feed adapter (208), receiving, in the transport engine (256) from the feed adapter (208), application messages (240), determining whether contents of the application messages (240) satisfy the transport layer constraint, and administering each of the application messages (240) in dependence upon whether the contents of the application message (240) satisfy the transport layer constraint.

In the exemplary system of FIG. 2, the transport layer constraint established in the transport engine (256) is characterized by a constraint value and a constraint operator. Using such a transport layer constraint, the transport engine (256) also operates generally for filtering application messages in a high speed, low latency data communications environment according to embodiments of the present invention by receiving, in the transport engine (256) from the feed adapter (208), a message contents proxy for each of the application messages, and applying the constraint operator to the constraint value and to the message contents proxy.

As mentioned above, the transport engine (256) of FIG. 2 receives both application messages (240) and message content proxies from the feed adapter (208). The transport engine (256) receives the application messages and the message contents proxies by receiving transport packets through the message stream (280) from the feed adapter (208), and unencapsulating the application messages and the message contents proxies from the received packets. In accordance with embodiments of the present invention, the transport engine (256) of FIG. 2 then provides the application messages (240) to messaging middleware (252) of the subscribing client device (210) if the contents of each application message (240) satisfy the transport layer constraint. In the example of FIG. 2, the messaging middleware (252) operates the transport engine (256) through a transport API (258) exposed by the transport engine (256).

After the transport engine (256) provides the application messages (240) to messaging middleware (252), the messaging middleware (252) of FIG. 2 further operates for filtering application messages in a high speed, low latency data communications environment according to embodiments of the present invention. Readers will recall that a middleware layer constraint on the application messages to be provided to the application (238) is established in the messaging middleware (276) of the subscribing client device (210). Using the middleware layer constraint, the messaging middleware (252) operates for filtering application messages in a high speed, low latency data communications environment according to embodiments of the present invention by determining whether contents of the application message satisfy a middleware layer constraint, and administering the application messages (240) in dependence upon whether contents of the application message satisfy the middleware layer constraint. Using both the transport layer constraint and the middleware layer constraint, the exemplary system of FIG. 2 advantageously provides the ability to filter application message in both the transport and messaging middleware layers of the network stack based on the contents of the application messages (240).

The servers and other devices illustrated in the exemplary system of FIG. 2 are for explanation, not for limitation. Devices useful in filtering application messages in a high speed, low latency data communications environment may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 2 are for explanation, not for limitation. Although the connections to the network (200) of FIG. 2 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 2, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 2.

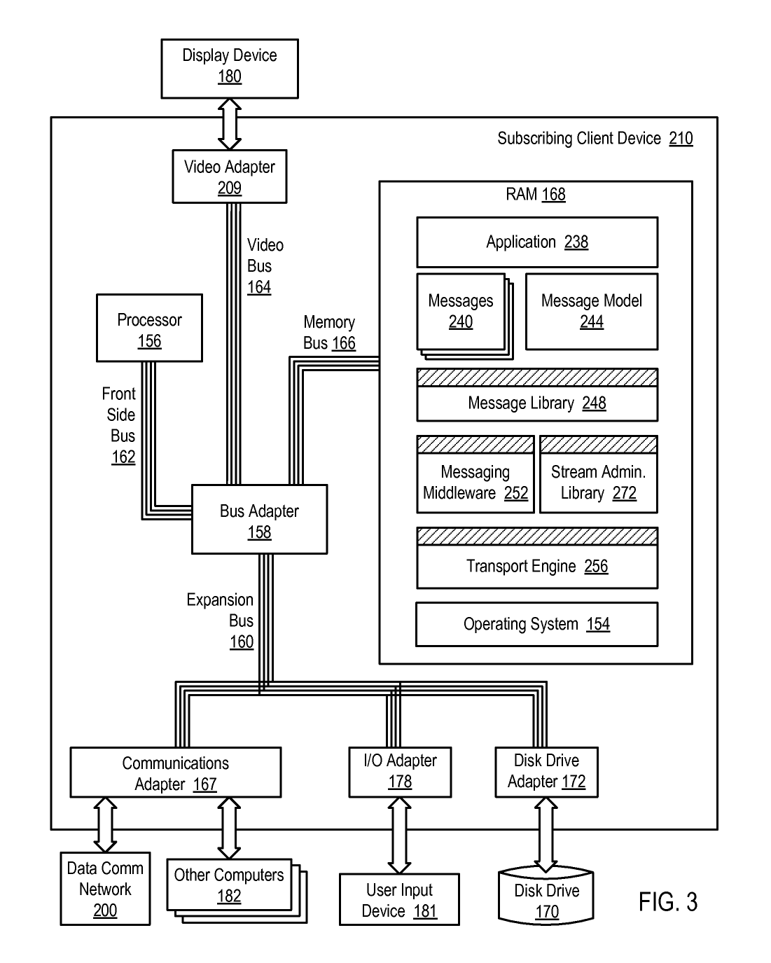

Filtering application messages in a high speed, low latency data communications environment in accordance with the present invention in some embodiments may be implemented with one or more subscribing client devices, stream administration servers, and feed adapters. These devices and servers are, in turn, implemented to some extent at least as computers, that is, automated computing machinery. For further explanation, therefore, FIG. 3 sets forth a block diagram of automated computing machinery comprising an exemplary subscribing client device (210) useful in filtering application messages in a high speed, low latency data communications environment according to embodiments of the present invention. The subscribing client device (210) of FIG. 3 includes at least one computer processor (156) or ‘CPU’ as well as random access memory (168) (‘RAM’) which is connected through a high speed memory bus (166) and bus adapter (158) to processor (156) and to other components of the subscribing client device.

Stored in RAM (168) is an application (238), messages (240), message model (244), a message library (248), a messaging middleware (252) a stream administration library (272), and a transport engine (256). Each message (240) is a quantity of data that includes one or more data fields and is transmitted from one device to another on a message stream. As mentioned above, a message may represent numeric or textual information, images, encrypted information, computer program instructions, and so on. In a financial market data environment, for example, a message is commonly referred to as a ‘tick’ and represents financial market data such as, for example, financial quotes or financial news. Each message (240) may be implemented using a structured document such as, for example, an XML document, a Java object, C++ object, or any other implementation as will occur to those of skill in the art. The message model (244) is metadata that defines the structure and format of the messages (240). The message model (244) may also be implemented using a structured document such as, for example, an XML document, a Java object, C++ object, or any other implementation as will occur to those of skill in the art. The application (238), the message library (248), the messaging middleware (252), the stream administration library (272), and the transport engine (256) illustrated in FIG. 3 are software components, that is computer program instructions, that operate as described above with reference to FIG. 2.

Also stored in RAM (168) is an operating system (154). Operating systems useful in subscribing client devices according to embodiments of the present invention include UNIX™, Linux™, Microsoft NT™, IBM's AIX™, IBM's i5/OS™, and others as will occur to those of skill in the art. The operating system (154), the application (238), the messages (240), the message model (244), the message library (248), the messaging middleware (252), and the transport engine (256) in the example of FIG. 3 are shown in RAM (168), but many components of such software typically are stored in non-volatile memory also, for example, on a disk drive (170).

The exemplary subscribing client device (210) of FIG. 3 includes bus adapter (158), a computer hardware component that contains drive electronics for high speed buses, the front side bus (162), the video bus (164), and the memory bus (166), as well as drive electronics for the slower expansion bus (160). Examples of bus adapters useful in subscribing client devices useful according to embodiments of the present invention include the Intel Northbridge, the Intel Memory Controller Hub, the Intel Southbridge, and the Intel I/O Controller Hub. Examples of expansion buses useful in subscribing client devices useful according to embodiments of the present invention may include Peripheral Component Interconnect (‘PCI’) buses and PCI Express (‘PCIe’) buses.

The exemplary subscribing client device (210) of FIG. 3 also includes disk drive adapter (172) coupled through expansion bus (160) and bus adapter (158) to processor (156) and other components of the exemplary subscribing client device (210). Disk drive adapter (172) connects non-volatile data storage to the exemplary subscribing client device (210) in the form of disk drive (170). Disk drive adapters useful in subscribing client devices include Integrated Drive Electronics (‘IDE’) adapters, Small Computer System Interface (‘SCSI’) adapters, and others as will occur to those of skill in the art. In addition, non-volatile computer memory may be implemented for a subscribing client device as an optical disk drive, electrically erasable programmable read-only memory (so-called ‘EEPROM’ or ‘Flash’ memory), RAM drives, and so on, as will occur to those of skill in the art.

The exemplary subscribing client device (210) of FIG. 3 includes one or more input/output (‘I/O’) adapters (178). I/O adapters in subscribing client devices implement user-oriented input/output through, for example, software drivers and computer hardware for controlling output to display devices such as computer display screens, as well as user input from user input devices (181) such as keyboards and mice. The exemplary subscribing client device (210) of FIG. 3 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary subscribing client device (210) of FIG. 3 includes a communications adapter (167) for data communications with other computers (182) and for data communications with a high speed, low latency data communications network (200). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for filtering application messages in a high speed, low latency data communications environment according to embodiments of the present invention include modems for wired dial-up communications, IEEE 802.3 Ethernet adapters for wired data communications network communications, and IEEE 802.11b adapters for wireless data communications network communications.

Although FIG. 3 is discussed with reference to exemplary subscribing client devices, readers will note that automated computing machinery used to implement exemplary stream administration servers and exemplary feed adapters useful in filtering application messages in a high speed, low latency data communications environment according to embodiments of the present invention are similar to the exemplary subscribing client device (210) of FIG. 3. That is, such exemplary stream administration servers and feed adapters include one or more processors, bus adapters, buses, RAM, video adapters, communications adapters, I/O adapters, disk drive adapters, and other components similar to the exemplary subscribing client device (210) of FIG. 3 as will occur to those of skill in the art.

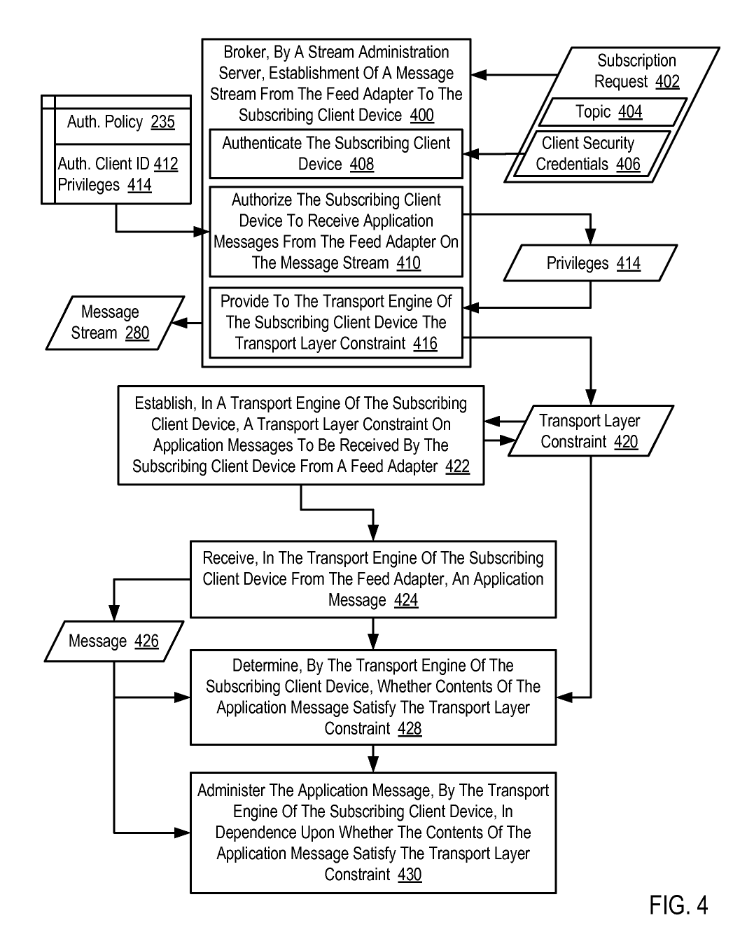

For further explanation, FIG. 4 sets forth a flowchart illustrating an exemplary method of filtering application messages in a high speed, low latency data communications environment in a high speed, low latency data communications environment according to embodiments of the present invention. The method of FIG. 4 includes brokering (400), by a stream administration server, establishment of a message stream (280) from the feed adapter to the subscribing client device. The message stream (280) represents a data communication channel between a communications endpoint of a subscribing client device and a communications endpoint of a feed adapter. A message stream may be implemented as a multicast data communication channel using the UDP/IP protocols or a unicast data communication channel using TCP/IP protocols as discussed above with reference to FIG. 2.

Brokering (400), by a stream administration server, establishment of a message stream (280) from the feed adapter to the subscribing client device according to the method of FIG. 4 may be carried out by receiving a subscription request (402) from a subscribing client device to subscribe to application messages from a feed adapter. The subscription request (402) is a request by an application of a subscribing client device to receive data from a feed adapter. The subscription request (402) of FIG. 4 may be implemented as an XML document, a call to a member method of a RMI object on the subscribing client device, or any other implementation as will occur to those of skill in the art.

The subscription request (402) of FIG. 4 includes the topics (404) of the application messages that the subscribing client device requests to receive from the feed adapter. A topic represents the characteristics of the messages that the subscribing client device requests to receive. Each application message typically includes a topic data field describing the information contained in the application message. Using a topic, a subscribing client device may specify the group of messages that the subscribing client device requests to receives from a feed adapter. In a financial market data environment, for example, a subscribing client device may use a topic to request to receive ticks from an OPRA feed source that contains quotes of an IBM option traded on the Chicago Board Options Exchange (‘CBOE’) that includes the best bid and best ask for the IBM option on the CBOE.

Brokering (400), by a stream administration server, establishment of a message stream (280) from the feed adapter to the subscribing client device according to the method of FIG. 4 may also be carried out by providing the subscribing client device a destination address for the feed adapter. The destination address for the feed adapter is a multicast address or a unicast address used by the subscribing client device to listen for messages from the feed adapter. Using the destination address provided by the stream administration server, the subscribing client device may establish the message stream (280) from the feed adapter to the subscribing client device.

Before the stream administration server provides the destination address for the feed adapter, the stream administration server in the example of FIG. 4 performs several security services to ensure that the subscribing client device only receives messages from the feed adapter for which the subscribing client device is authorized to receive. In the method of FIG. 4, brokering (400), by a stream administration server, establishment of a message stream (280) from the feed adapter to the subscribing client device includes authenticating (408) the subscribing client device. Authenticating (408) the subscribing client device according to the method of FIG. 4 may be carried out by verifying client security credentials (406) provided by the subscribing client device with the subscription request (402). The client security credentials (406) may be implemented as a digital signature in a public key infrastructure, a security token, or any other security data as will occur to those of skill in the art for authenticating the identity of the originator of the subscription request (402). Examples of security token may include those security tokens described in the web services specification entitled ‘Web Services Security’ (‘WS-Security’) developed by IBM, Microsoft, and VeriSign or the web services specification entitled ‘Web Services Trust Language’ (‘WS-Trust’) developed by IBM, Microsoft, VeriSign, OpenNetworks, Layer 7, Computer Associates, BEA, Oblix, Reactivity, RSA Security, Ping Identity, and Actional.

In the method of FIG. 4, brokering (400), by a stream administration server, establishment of a message stream (280) from the feed adapter to the subscribing client device also includes authorizing (410) the subscribing client device to receive application messages from the feed adapter on the message stream (280). Authorizing (410) the subscribing client device to receive application messages from the feed adapter on the message stream (280) according to the method of FIG. 4 may be carried out by identifying the privileges (414) associated with the authenticated subscribing client device in dependence upon an authorization policy (235). The authorization policy (235) is a set of rules governing the privileges of authenticated subscribing client devices requesting to receive data from a feed adapter. In the example of FIG. 4, the authorization policy (235) associates privileges (414) with an authenticated subscribing client device identifier (412). The authenticated subscribing client device identifier (412) represents a subscribing client device authenticated by a stream administration server. The privileges (414) represent the set of application messages permissible for an authenticated subscribing client device identified by the associated authenticated subscribing client device identifier (414) to receive from a feed adapter. Different authenticated subscribing client devices may have difference privileges. Although the authorization policy (235) depicted in FIG. 4 associates individual authenticated users with certain privileges, such a depiction is for explanation and not for limitation. The authorization policy (235) may, in fact, grant privileges on the basis of a subscribing client device's membership in a group or on any other basis as will occur to those of skill in the art.

Brokering (400), by a stream administration server, establishment of a message stream (280) from the feed adapter to the subscribing client device according to the method of FIG. 4 also includes providing (416) to the transport engine of the subscribing client device the transport layer constraint (420). The transport layer constraint (420) represents a constraint on application messages to be received by the subscribing client device (210) from a feed adapter (208). The transport layer constraint specifies the characteristics of the application messages which a subscribing client device is authorized to receive from a feed adapter. The transport layer constraint is so-called because it is applied to the application messages by a software component operating in the transport layer of the network protocol stack as opposed to being applied by a software component operating in the application layer. In a financial market data environment, for example, transport layer constraints may specify that a particular authenticated subscribing client device is authorized to receive ticks from an OPRA feed source that contains quotes of an IBM option traded on the Chicago Board Options Exchange (‘CBOE’) that include the best bid and best ask for the IBM option on the CBOE.

In the method of FIG. 4, providing (416) to the transport engine of the subscribing client device the transport layer constraint (420) may be carried out by returning the transport layer constraint (420) to a subscribing client device in response to a function call by a stream administration library that provided the subscription request (402). Providing (416) to the transport engine of the subscribing client device the transport layer constraint (420) according to the method of FIG. 4 may also be carried out by returning data to the subscribing client device from which the subscribing client device may derive the transport layer constraint (420). For example, the subscribing client device may be provided the topic of the application messages that the subscribing client device is authorized to receive, and the subscribing client device may then derive the transport layer constraint (420) as a hash value of the received topic.

The method of FIG. 4 also includes establishing (422), in a transport engine of a subscribing client device, a transport layer constraint (420) on application messages to be received by the subscribing client device from a feed adapter. The transport engine of the subscribing client device may establish (422) the transport layer constraint (420) in the transport engine by receiving the transport layer constraint (420) directly from a stream administration server or indirectly from the stream administration server through messaging middleware of the subscribing client device. The transport engine of the subscribing client device may further establish (422) the transport layer constraint (420) in the transport engine by storing the transport layer constraint (420) in a constraints table (not shown) in the transport engine. Such a constraints table may be used by the transport engine as a convenient data structure for storing multiple transport layer constraints.

The method of FIG. 4 includes receiving (424), in the transport engine of the subscribing client device from the feed adapter, an application message (426). The application message (426) represents a quantity of data that includes one or more data fields such as, for example, numeric or textual information, images, encrypted information, computer program instructions, and so on. The application message (416) is capable of being passed from a feed adapter to a subscribing client device. As mentioned above, in a financial market data environment, a message is commonly referred to as a ‘tick’ and represents financial market data such as, for example, financial quotes or financial news. Receiving (424), in the transport engine of the subscribing client device from the feed adapter, an application message (426) according to the method of FIG. 4 may be carried out by receiving transport packets through the message stream (280) from the feed adapter (208) and unencapsulating the application messages from the received transport packets.

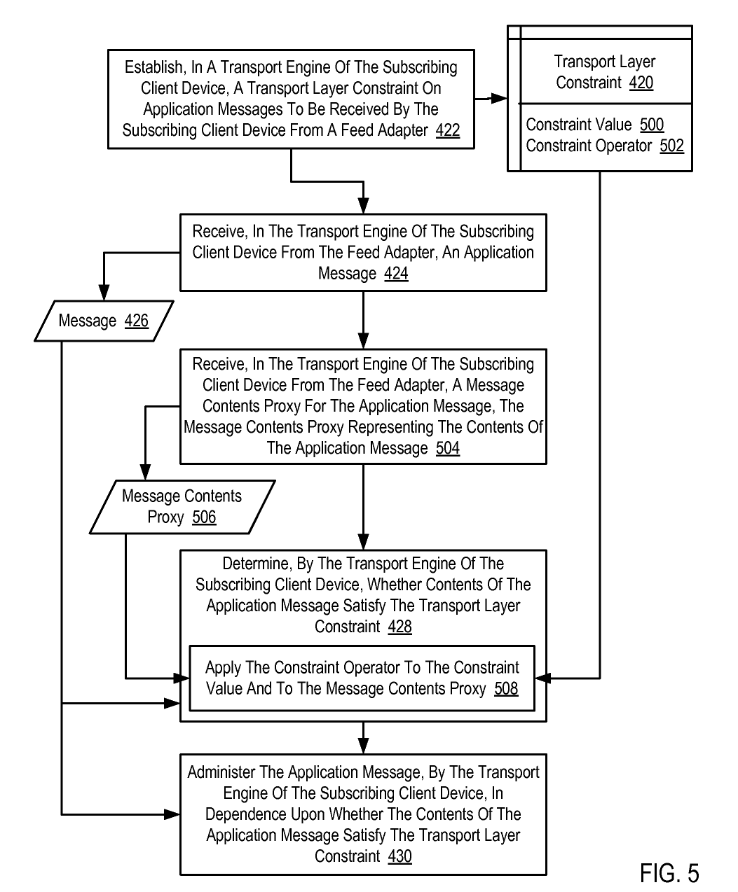

The method of FIG. 4 includes determining (428), by the transport engine of the subscribing client device, whether contents of the application message (426) satisfy the transport layer constraint (420). Determining (428), by the transport engine of the subscribing client device, whether contents of the application message (426) satisfy the transport layer constraint (420) according to the method of FIG. 4 may be carried out by applying a constraint operator of the transport layer constraint (420) to a constraint value of the constraint (420) and to a message contents proxy as discussed below with reference to FIG. 5.

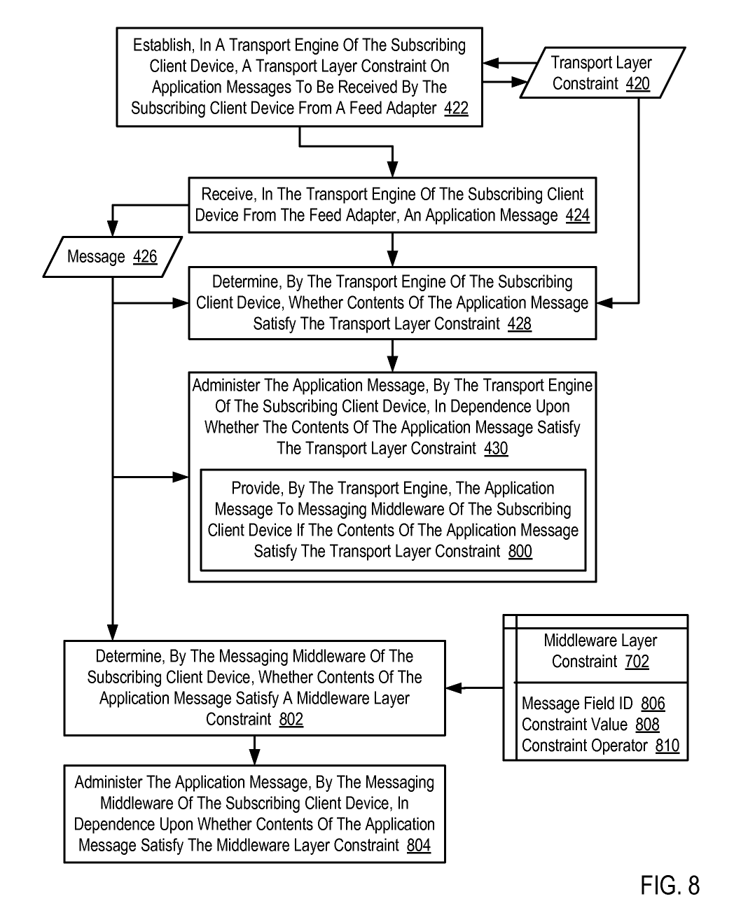

The method of FIG. 4 also includes administering (430) the application message (426), by the transport engine of the subscribing client device, in dependence upon whether the contents of the application message (426) satisfy the transport layer constraint (420). Administering (430) the application message (426), by the transport engine of the subscribing client device, in dependence upon whether the contents of the application message (426) satisfy the transport layer constraint (420) according to the method of FIG. 4 may be carried out by providing, by the transport engine, the application message to messaging middleware of the subscribing client device if the contents of the application message (426) satisfy the transport layer constraint (420) as discussed below with reference to FIG. 8. Administering (430) the application message (426), by the transport engine of the subscribing client device, in dependence upon whether the contents of the application message (426) satisfy the transport layer constraint (420) according to the method of FIG. 4 may also be carried out by discarding the application message (426) if the contents of the application message (426) do not satisfy the transport layer constraint (420).

As mentioned above, the transport engine of the subscribing client device may determine whether contents of the application message satisfy the transport layer constraint by applying a constraint operator of the transport layer constraint to a constraint value of the constraint and to a message contents proxy. For further explanation, therefore, FIG. 5 sets forth a flowchart illustrating a further exemplary method of filtering application messages in a high speed, low latency data communications environment in a high speed, low latency data communications environment according to embodiments of the present invention that includes applying (508) the constraint operator (502) to the constraint value and to the message contents proxy (506).

The method of FIG. 5 is similar to the method of FIG. 4. That is, the method of FIG. 5 includes establishing (422), in a transport engine of a subscribing client device, a transport layer constraint (420) on application messages to be received by the subscribing client device from a feed adapter, receiving (424), in the transport engine of the subscribing client device from the feed adapter, an application message (426), determining (428), by the transport engine of the subscribing client device, whether contents of the application message (426) satisfy the transport layer constraint (420), and administering (430) the application message (426), by the transport engine of the subscribing client device, in dependence upon whether the contents of the application message (426) satisfy the transport layer constraint (420).

In the example of FIG. 5, the transport layer constraint (420) is characterized by a constraint value (500) and a constraint operator (502). The constraint value (500) represents a value used to specify the characteristics of the application messages that a subscribing client device is authorized to receive from a feed adapter. The constraint operator (502) represents a relationship between the application messages and the constraint value (500). The constraint value (500) of FIG. 5 may represent a value that is compared directly with one or more data fields of an application message or indirectly using another value derived from one or more data fields of an application message. In a financial market data environment, for example, the constraint value (500) may be implemented as a hash value calculated using the data from the topic field of a financial market data tick. When the constraint value (500) is implemented as a hash value, the constraint operator (502) may specify that a message contents proxy for an application message is either equal to or not equal to the constraint value (500). Readers will note, however, that implementing the constraint value as a hash value is for explanation only and not for limitation. Constraint values useful according to the present invention may be implemented in other ways as will occur to those of skill in the art such as for example, a possible value for a data field in an application message or a value derived from one or more data fields. Similarly, constraint operators useful according to the present invention may be implemented in other ways as will occur to those of skill in the art such as, for example, ‘>’, ‘<’, ‘CONTAINS,’ ‘ENDS WITH,’ and so on.

In the example of FIG. 5, the transport layer constraint (420) explicitly associates a constraint operation (502) with each constraint value (500). Readers will note, however, that if the value of the constraint operator (502) is the same for each constraint value (500), then the transport layer constraint (420) may implicitly associate a constraint operation (502) with each constraint value (500). Continuing with the exemplary financial market data environment mentioned above in which each constraint value (500) is implemented as a hash value, the transport layer constraint (420) may implicitly specify a constraint operator (502) for each constraint value (500) as ‘=.’ In such an example, therefore, the transport layer constraint (420) may be implemented as a list of hash values that imply the message contents proxy for an application message must equal one of the hash values.

The method of FIG. 5 includes receiving (504), in the transport engine of the subscribing client device from the feed adapter, a message contents proxy (506) for the application message (426). The message contents proxy (506) represents a value that represents the contents of the application message. In the example of FIG. 5, the message contents proxy (506) represents a value that is derived from one or more of the message fields of the application message (426). In a financial market data environment, for example, the message contents proxy (506) may be implemented as a hash value calculated using the data from the topic field of a financial market data tick. The transport engine of the subscribing client device may receive (504) the message contents proxy (506) for the application message (426) from the feed adapter by receiving transport packets that contain the message contents proxy (506), which is typically prepended to the beginning of the application message (426), and unencapsulating the message contents proxy (506) from the transport packets.

In the method of FIG. 5, determining (428), by the transport engine of the subscribing client device, whether contents of the application message (426) satisfy the transport layer constraint (420) is carried out by applying (508) the constraint operator (502) to the constraint value (500) and to the message contents proxy (506). Applying (508) the constraint operator (502) to the constraint value and to the message contents proxy (506) according to the method of FIG. 5 may be carried out by comparing the constraint value (500) to the message contents proxy (506) according to the constraint operator (502). If the comparison of the constraint value (500) to the message contents proxy (506) according to the constraint operator (502) evaluates to true, then the contents of the application message (426) satisfy the transport layer constraint (420). If the comparison of the constraint value (500) to the message contents proxy (506) according to the constraint operator (502) evaluates to false, then the contents of the application message (426) do not satisfy the transport layer constraint (420). Based on the determination (428) by the transport engine, the transport engine then administers (430) the application message in dependence upon whether the contents of the application message (426) satisfy the transport layer constraint (420) as discussed above with reference to FIG. 4.

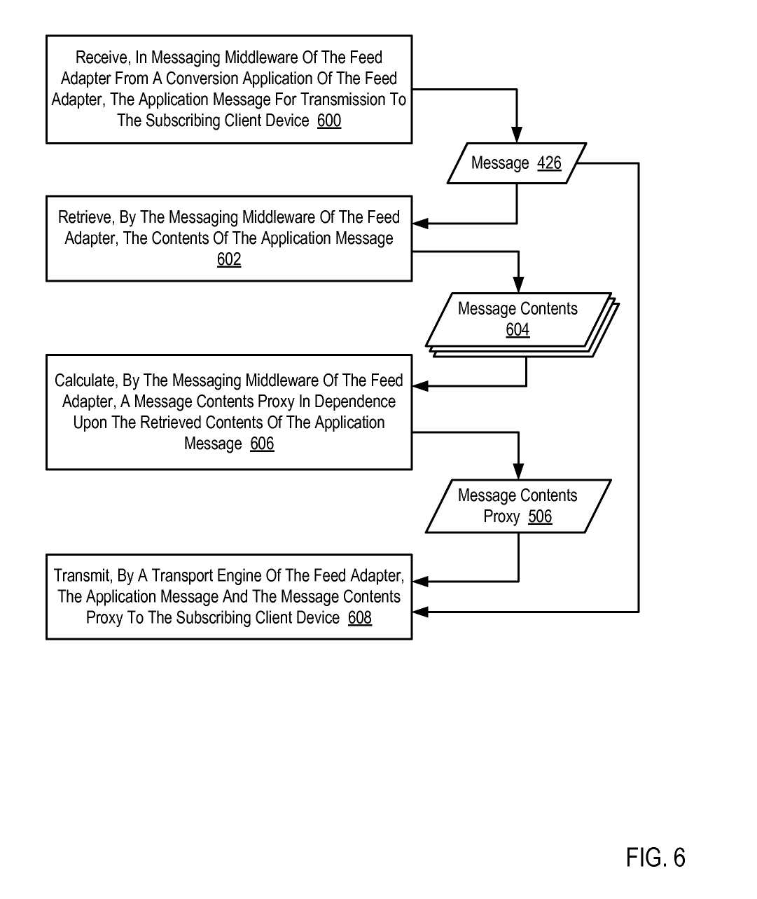

As mentioned above, the transport engine of the subscribing client device receives a message contents proxy for the application message from the feed adapter. Typically, the message contents proxy is calculated by the feed adapter and transmitted along with the application message to the subscribing client device. For further explanation, therefore, FIG. 6 sets forth a flowchart illustrating a further exemplary method of filtering application messages in a high speed, low latency data communications environment in a high speed, low latency data communications environment according to embodiments of the present invention that includes calculating (606), in messaging middleware of a feed adapter, a message contents proxy (506) in dependence upon the retrieved contents (604) of an application message (426).

Prior to calculating (606) a message contents proxy (506), the method of FIG. 6 includes receiving (600), in messaging middleware of the feed adapter from a conversion application of the feed adapter, the application message (426) for transmission to the subscribing client device. The conversion application is a software component installed on the feed adapter that converts application messages having a first format received on a feed adapter input stream from a feed source to application messages having a second format for transmission to a subscribing client device on a feed adapter output stream. In the method of FIG. 6, the messaging middleware of the feed adapter may receive (600) the application message (426) from the conversion application by receiving a copy of the application message (426) or a pointer to the application message (426) when the conversion application invokes a function of the messaging middleware API.

The method of FIG. 6 also includes retrieving (602), by the messaging middleware of the feed adapter, the contents (604) of the application message (426). The message contents (604) represent values from one or more of the message fields in the application message (426). Messaging middleware of the feed adapter may retrieve (602) the contents (604) of the application message (426) by reading values directly from one or more message fields of the application message (426) using a message model that describes the location of the message fields in the message (426). Rather than reading a value directly from a message field of the application message (426), messaging middleware may also retrieve (602) the contents (604) of the application message (426) by passing the application message (426) and a message field name to a function of a messaging library on the feed adapter and receiving, in return, the value from the message field of the application message (426) identified by the message field name.

As mentioned above, the method of FIG. 6 includes calculating (606), by the messaging middleware of the feed adapter, a message contents proxy (506) in dependence upon the retrieved contents (604) of the application message (426). The messaging middleware of the feed adapter may calculate (606) a message contents proxy (506) according to the method of FIG. 6 by concatenating the message contents (604) together and executing a hash algorithm over the concatenated message contents. The result calculated using the hash algorithm may be implemented as the message contents proxy (506). In the example of FIG. 6, the fields of the application message (426) retrieved by the feed adapter and used to calculate the message contents proxy (506) correspond to the message fields specified by the transport layer constraint or any middleware layer constraint used to filter the application message.

The method of FIG. 6 also includes transmitting (608), by a transport engine of the feed adapter, the application message (426) and the message contents proxy (506) to the subscribing client device. The transport engine of the feed adapter may transmit (608) the application message (426) and the message contents proxy (506) to the subscribing client device according to method of FIG. 6 by prepending the message contents proxy (506) to the application message (436), encapsulating the message contents proxy (506) and the application message (436) into one or more transport packets, and transmitting the transport packets to a transport engine in the subscribing client device. Transmitting the message contents proxy (506) to the transport engine of the subscribing client device advantageously allows the subscribing client device to filter application messages in the transport layer based on the contents of the application message without having to examine the actual contents of the application messages in the transport layer. By removing the need to examine the actual contents of the application messages and providing the filtering functionality in the transport layer of the subscribing client device based on a message contents proxy and a transport layer constraint, filtering application messages may be effectively carried out in a high speed, low latency data communications environment.

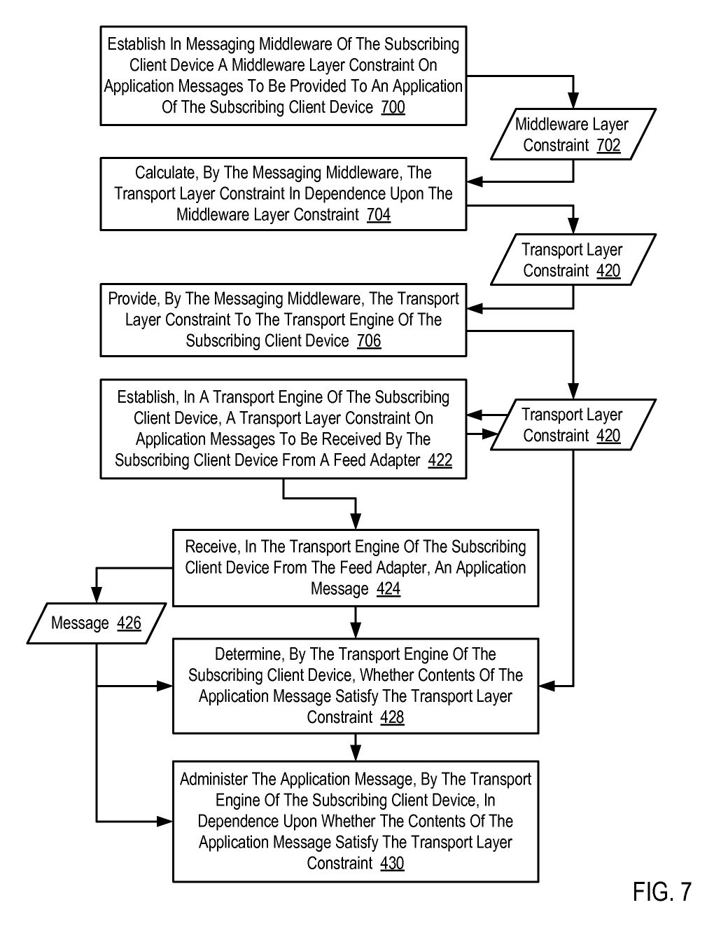

As mentioned above, when the transport layer constraint is established in the transport engine of the subscribing client device, the transport engine of the subscribing client device may receive the transport layer constraint (420) directly from a stream administration server. In addition, the transport engine of the subscribing client device may also receive the transport layer constraint (420) indirectly from the stream administration server through messaging middleware of the subscribing client device. For further explanation, therefore, FIG. 7 sets forth a flowchart illustrating a further exemplary method of filtering application messages in a high speed, low latency data communications environment in a high speed, low latency data communications environment according to embodiments of the present invention that includes providing (706), by the messaging middleware, the transport layer constraint (420) to the transport engine of the subscribing client device.

The method of FIG. 7 is similar to the method of FIG. 4. That is, the method of FIG. 7 includes establishing (422), in a transport engine of a subscribing client device, a transport layer constraint (420) on application messages to be received by the subscribing client device from a feed adapter, receiving (424), in the transport engine of the subscribing client device from the feed adapter, an application message (426), determining (428), by the transport engine of the subscribing client device, whether contents of the application message (426) satisfy the transport layer constraint (420), and administering (430) the application message (426), by the transport engine of the subscribing client device, in dependence upon whether the contents of the application message (426) satisfy the transport layer constraint (420).

The method of FIG. 7 includes establishing (700) in messaging middleware of the subscribing client device a middleware layer constraint (702) on application messages to be provided to an application of the subscribing client device. The middleware layer constraint (702) represents a constraint on application messages to be provided to application software installed on the subscribing client device. The middleware layer constraint specifies the characteristics of the application messages which application software installed on the subscribing client device is authorized to receive from the messaging middleware of the subscribing client device. The middleware layer constraint is applied to the application messages by a software component, such as messaging middleware, operating between the transport layer and the application layer of the network protocol stack as opposed to being applied by a software component operating in the application layer.

Establishing (700) in messaging middleware of the subscribing client device a middleware layer constraint (702) on application messages to be provided to an application of the subscribing client device according to the method of FIG. 7 may be carried out by receiving the middleware layer constraint (702) from a stream administration server or from some other system administration device. The messaging middleware of the subscribing client device may further establish (700) the middleware layer constraint (702) in the messaging middleware by storing the middleware layer constraint (702) in a constraints table (not shown) in the messaging middleware. Such a constraints table may be used by the messaging middleware as a convenient data structure for storing multiple middleware layer constraints.

The method of FIG. 7 also includes calculating (704), by the messaging middleware, the transport layer constraint (420) in dependence upon the middleware layer constraint (702). The messaging middleware of the subscribing client device may calculate (704) the transport layer constraint (420) according to the method of FIG. 7 by executing a hash algorithm over a value for a message field specified in the middleware layer constraint (702). The result calculated using the hash algorithm may be implemented as the transport layer constraint (420).

The method of FIG. 7 includes providing (706), by the messaging middleware, the transport layer constraint (420) to the transport engine of the subscribing client device. The messaging middleware of the subscribing client device may provide (706) the transport layer constraint (420) to the transport engine of the subscribing client device according to the method of FIG. 7 by calling a function in the transport engine API that will provide the transport engine with a copy of the transport layer constraint (420) or a pointer in memory to the location of the transport layer constraint. After the messaging middleware provides (706) the transport layer constraint (420) to the transport engine of the subscribing client device, the method of FIG. 7 continues in a manner similar to the method of FIG. 4.

As mentioned above, the transport engine of the subscribing client device may administer an application message in dependence upon whether the contents of the application message satisfy the transport layer constraint by providing the application message to messaging middleware of the subscribing client device if the contents of the application message satisfy the transport layer constraint. For further explanation, therefore, FIG. 8 sets forth a flowchart illustrating a further exemplary method of filtering application messages in a high speed, low latency data communications environment in a high speed, low latency data communications environment according to embodiments of the present invention that includes providing (800), by the transport engine, the application message to messaging middleware of the subscribing client device if the contents of the application message (426) satisfy the transport layer constraint (420).

The method of FIG. 8 is similar to the method of FIG. 4. That is, the method of FIG. 8 includes establishing (422), in a transport engine of a subscribing client device, a transport layer constraint (420) on application messages to be received by the subscribing client device from a feed adapter, receiving (424), in the transport engine of the subscribing client device from the feed adapter, an application message (426), determining (428), by the transport engine of the subscribing client device, whether contents of the application message (426) satisfy the transport layer constraint (420), and administering (430) the application message (426), by the transport engine of the subscribing client device, in dependence upon whether the contents of the application message (426) satisfy the transport layer constraint (420).

In the method of FIG. 8, administering (430) the application message (426), by the transport engine of the subscribing client device, in dependence upon whether the contents of the application message (426) satisfy the transport layer constraint (420) includes providing (800), by the transport engine, the application message to messaging middleware of the subscribing client device if the contents of the application message (426) satisfy the transport layer constraint (420). The transport engine may provide (800) the application message to messaging middleware of the subscribing client device by returning a copy of the application message (426) or a pointer in memory to the application message (426) in response to the messaging middleware calling a function of the transport engine API.

The example of FIG. 8 includes a middleware layer constraint (702) similar to the middleware layer constraint described above. The middleware layer constraint (702) is characterized by a message field identifier (806), a constraint value (808), and a constraint operator (810). The message field identifier (806) identifies a message field in the application message (426) used to obtain the contents of the message (426). The constraint value (808) represents a value used to specify the characteristics of the application messages that a subscribing client device is authorized to receive from a feed adapter. The constraint operator (810) represents a relationship between the application messages and the constraint value (808). The constraint value (808) of FIG. 8 may represent a value that is compared directly with one or more data fields of an application message or indirectly using another value derived from one or more data fields of an application message. In a financial market data environment, for example, the constraint value (808) may be implemented as one of the possible values for the topic field of a financial market data tick. The constraint operator (810) may specify simple operators such as, for example, ‘=’, ‘>’, or ‘<’, or specify more complex operator such as, for example, ‘CONTAINS,’ ‘DOES NOT EQUAL,’ ‘ENDS WITH,’ and so on. For example, consider a middleware layer constraint having a constraint value (808) of ‘IBM/OPRA’ and a constraint operator (810) having a value of ‘CONTAINS.’ Such an exemplary transport layer constraint specifies that a subscribing client device is authorized to receive all the ticks of IBM securities disseminated from OPRA participating financial exchanges.

The method of FIG. 8 includes determining (802), by the messaging middleware of the subscribing client device, whether contents of the application message (426) satisfy a middleware layer constraint (702). The messaging middleware of the subscribing client device may determine (802) whether contents of the application message (426) satisfy a middleware layer constraint (702) according to the method of FIG. 8 by comparing the constraint value (808) to a value from a message field in the application message (426) identified by the message field identifier (806) in accordance with the constraint operator (810). If the comparison of the constraint value (808) to the value from a message field of the message (426) according to the constraint operator (810) evaluates to true, then the contents of the application message (426) satisfy the middleware layer constraint (702). If the comparison of the constraint value (808) to the value from a message field of the message (426) according to the constraint operator (810) evaluates to false, then the contents of the application message (426) do not satisfy the middleware layer constraint (702).

The method of FIG. 8 also includes administering (804) the application message (426), by the messaging middleware of the subscribing client device, in dependence upon whether contents of the application message (426) satisfy the middleware layer constraint (702). The messaging middleware of the subscribing client device may administer (804) the application message (426) according to the method of FIG. 8 by providing the application message (426) to application software installed on the subscribing client device if the contents of the application message (426) satisfy the middleware layer constraint (702). The messaging middleware of the subscribing client device may administer (804) the application message (426) according to the method of FIG. 8 by discarding the application message (426) if the contents of the application message (426) do not satisfy the middleware layer constraint (702).

Administering (804) the application message (426) in the messaging middleware layer of the subscribing client device according to the method of FIG. 8 advantageously provides a second tier of filtering for application message in the messaging middleware layer. Such second tier filtering is useful because the filtering of application messages that first occurs in the transport layer, as described above, is often carried out by comparing hash values representing the contents of the application messages. With any hashing algorithm, there exists the possibility that hashing collisions will occur over the range of inputs for the hashing algorithm. A hashing collision occurs when two different inputs to a hashing algorithm produce the same hash value. The second tier of filtering the application messages in the messaging middleware layer is not typically implemented using hash values, but rather such filtering is based on the actual content of each message. In this manner, the second tier of filtering is immune to hashing collisions. Readers will note, therefore, that the first tier of filtering that occurs in the transport layer advantageously operates to filter out most of the application message for which a subscribing client device is not authorized to receive. The second tier of filtering in the messaging middleware layer may then operate to filter out application message for which a subscribing client device is not authorized to receive that penetrated through the transport layer due to a hashing collision. The application messages that satisfy both the transport layer constraint and the middleware layer constraint are then provided to application software in the application layer of the subscribing client device.

In view of the explanations set forth above in this document, readers will recognize that filtering application messages in a high speed, low latency data communications environment according to embodiments of the present invention provides the following benefits:
the ability to filter messages at the transport layer of the network protocol stack that are created and utilized in the application layer of the network protocol stack,
the ability to filter messages in the transport layer based on the contents of the application messages without having to examine the actual contents of the application messages when they are received in the transport layer, and
the ability to provide a second tier of filtering for application message at the messaging middleware layer after filtering the application messages in the transport layer.

Exemplary embodiments of the present invention are described largely in the context of a fully functional computer system for filtering application messages in a high speed, low latency data communications environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of filtering application messages in a high speed, low latency data communications environment, the method comprising:
establishing, in a transport engine of a subscribing client device, a transport layer constraint on application messages to be received by the subscribing client device from a feed adapter;
receiving, in the transport engine of the subscribing client device from the feed adapter, an application message;
determining, by the transport engine of the subscribing client device, whether contents of the application message satisfy the transport layer constraint; and
administering the application message, by the transport engine of the subscribing client device, in dependence upon whether the contents of the application message satisfy the transport layer constraint.

2. The method of claim 1 further comprising:
receiving, in the transport engine of the subscribing client device from the feed adapter, a message contents proxy for the application message, the message contents proxy representing the contents of the application message;
wherein the transport layer constraint is characterized by a constraint value and a constraint operator, and
wherein determining whether the contents of the application message satisfy the transport layer constraint further comprises applying the constraint operator to the constraint value and to the message contents proxy.

3. The method of claim 1 further comprising:
receiving, in messaging middleware of the feed adapter from a conversion application of the feed adapter, the application message for transmission to the subscribing client device;
retrieving, by the messaging middleware of the feed adapter, the contents of the application message;
calculating, by the messaging middleware of the feed adapter, a message contents proxy in dependence upon the retrieved contents of the application message; and
transmitting, by a transport engine of the feed adapter, the application message and the message contents proxy to the subscribing client device.

4. The method of claim 1 further comprising:
brokering, by a stream administration server, establishment of a message stream from the feed adapter to the subscribing client device, including authenticating the subscribing client device, authorizing the subscribing client device to receive application messages from the feed adapter on the message stream, and providing to the transport engine of the subscribing client device the transport layer constraint.

5. The method of claim 1 further comprising:
establishing in messaging middleware of the subscribing client device a middleware layer constraint on application messages to be provided to an application of the subscribing client device;
calculating, by the messaging middleware, the transport layer constraint in dependence upon the middleware layer constraint; and
providing, by the messaging middleware, the transport layer constraint to the transport engine of the subscribing client device.

6. The method of claim 1 wherein administering the application message, by the transport engine of the subscribing client device, in dependence upon whether the contents of the application message satisfy the transport layer constraint further comprises providing, by the transport engine, the application message to messaging middleware of the subscribing client device if the contents of the application message satisfy the transport layer constraint; and
the method further comprises:
determining, by the messaging middleware of the subscribing client device, whether contents of the application message satisfy a middleware layer constraint; and
administering the application message, by the messaging middleware of the subscribing client device, in dependence upon whether contents of the application message satisfy the middleware layer constraint.

7. The method of claim 1 wherein the feed adapter comprises a device having the capabilities of converting application messages received on a feed adapter input stream having a first format to application messages having a second format for transmission on a feed adapter output stream to subscribing client devices.

8. The method of claim 1 wherein the application message comprises financial market data.

9. A system for filtering application messages in a high speed, low latency data communications environment, the system comprising one or more computer processors, computer memory operatively coupled to the one or more computer processors, the computer memory having disposed within it computer program instructions capable of:
establishing, in a transport engine of a subscribing client device, a transport layer constraint on application messages to be received by the subscribing client device from a feed adapter;
receiving, in the transport engine of the subscribing client device from the feed adapter, an application message;
determining, by the transport engine of the subscribing client device, whether contents of the application message satisfy the transport layer constraint; and
administering the application message, by the transport engine of the subscribing client device, in dependence upon whether the contents of the application message satisfy the transport layer constraint.

10. The system of claim 9 further comprising computer program instructions capable of:
receiving, in the transport engine of the subscribing client device from the feed adapter, a message contents proxy for the application message, the message contents proxy representing the contents of the application message;
wherein the transport layer constraint is characterized by a constraint value and a constraint operator, and
wherein determining whether the contents of the application message satisfy the transport layer constraint further comprises applying the constraint operator to the constraint value and to the message contents proxy.

11. The system of claim 9 further comprising computer program instructions capable of:
receiving, in messaging middleware of the feed adapter from a conversion application of the feed adapter, the application message for transmission to the subscribing client device;
retrieving, by the messaging middleware of the feed adapter, the contents of the application message;
calculating, by the messaging middleware of the feed adapter, a message contents proxy in dependence upon the retrieved contents of the application message; and
transmitting, by a transport engine of the feed adapter, the application message and the message contents proxy to the subscribing client device.

12. The system of claim 9 further comprising computer program instructions capable of:
brokering, by a stream administration server, establishment of a message stream from the feed adapter to the subscribing client device, including authenticating the subscribing client device, authorizing the subscribing client device to receive application messages from the feed adapter on the message stream, and providing to the transport engine of the subscribing client device the transport layer constraint.

13. A computer program product for filtering application messages in a high speed, low latency data communications environment, the computer program product disposed upon a signal bearing medium, the computer program product comprising computer program instructions capable of:
establishing, in a transport engine of a subscribing client device, a transport layer constraint on application messages to be received by the subscribing client device from a feed adapter;
receiving, in the transport engine of the subscribing client device from the feed adapter, an application message;
determining, by the transport engine of the subscribing client device, whether contents of the application message satisfy the transport layer constraint; and
administering the application message, by the transport engine of the subscribing client device, in dependence upon whether the contents of the application message satisfy the transport layer constraint.

14. The computer program product of claim 13 wherein the signal bearing medium comprises a recordable medium.

15. The computer program product of claim 13 wherein the signal bearing medium comprises a transmission medium.

16. The computer program product of claim 13 further comprising computer program instructions capable of:
receiving, in the transport engine of the subscribing client device from the feed adapter, a message contents proxy for the application message, the message contents proxy representing the contents of the application message;
wherein the transport layer constraint is characterized by a constraint value and a constraint operator, and
wherein determining whether the contents of the application message satisfy the transport layer constraint further comprises applying the constraint operator to the constraint value and to the message contents proxy.

17. The computer program product of claim 13 further comprising computer program instructions capable of:
receiving, in messaging middleware of the feed adapter from a conversion application of the feed adapter, the application message for transmission to the subscribing client device;
retrieving, by the messaging middleware of the feed adapter, the contents of the application message;
calculating, by the messaging middleware of the feed adapter, a message contents proxy in dependence upon the retrieved contents of the application message; and
transmitting, by a transport engine of the feed adapter, the application message and the message contents proxy to the subscribing client device.

18. The computer program product of claim 13 further comprising computer program instructions capable of:
brokering, by a stream administration server, establishment of a message stream from the feed adapter to the subscribing client device, including authenticating the subscribing client device, authorizing the subscribing client device to receive application messages from the feed adapter on the message stream, and providing to the transport engine of the subscribing client device the transport layer constraint.

19. The computer program product of claim 13 further comprising computer program instructions capable of:
establishing in messaging middleware of the subscribing client device a middleware layer constraint on application messages to be provided to an application of the subscribing client device;
calculating, by the messaging middleware, the transport layer constraint in dependence upon the middleware layer constraint; and
providing, by the messaging middleware, the transport layer constraint to the transport engine of the subscribing client device.

20. The computer program product of claim 13 wherein administering the application message, by the transport engine of the subscribing client device, in dependence upon whether the contents of the application message satisfy the transport layer constraint further comprises providing, by the transport engine, the application message to messaging middleware of the subscribing client device if the contents of the application message satisfy the transport layer constraint; and
the system further comprises computer program instructions capable of:
determining, by the messaging middleware of the subscribing client device, whether contents of the application message satisfy a middleware layer constraint; and
administering the application message, by the messaging middleware of the subscribing client device, in dependence upon whether contents of the application message satisfy the middleware layer constraint.
